(19) United States
(12) Patent Application Publication
(10) Pub. No.: US 2025/0024393 A1
(43) Pub. Date: Jan. 16, 2025

(54) APPARATUSES AND METHODS RELATING TO UPDATING AN INTERNAL CLOCK OF A MOBILE DEVICE

(71) Applicant: Nokia Technologies Oy, Espoo (FI)

(72) Inventors: Renato Barbosa ABREU, Aalborg (DK); Thomas Haaning JACOBSEN, Aalborg (DK); Benny VEJLGAARD, Aalborg (DK); Oana-Elena BARBU, Aalborg (DK); Johannes HARREBEK, Aalborg (DK); Jan Torst HVIID, Aalborg (DK)

(21) Appl. No.: 18/705,219

(22) PCT Filed: Oct. 29, 2021
(86) PCT No.: PCT/EP2021/080135

§ 371 Date: Apr. 26, 2024

(51) Int. Cl. H04W 56/00

(52) U.S. Cl. CPC H04W 56/005; H04W 56/001

(57) ABSTRACT

The specification describes apparatus comprising means for: estimating a propagation delay of transmissions between a base station and a mobile device based on data from at least one motion sensor that is local to the mobile device; determining updated timing information based on the estimated propagation delay; and updating an internal clock of the mobile device in accordance with the updated timing information.

### FIELD

This specification describes apparatuses and methods relating to estimation of a propagation delay.

### BACKGROUND

Accurate time synchronisation between nodes of radio networks may be beneficial for supporting ultra-reliable and low latency communications (URLLC), Industrial Internet of Things (IIoT) use-cases and also for supporting Time Sensitive Networking (TSN) or Time Sensitive Communications (TSC) applications (see e.g. 3GPP TS 23.501, Release-16). Accurate time synchronization may also help to ensure that different nodes of a radio (e.g. 5G) network (e.g. UPF, gNB, UE) share the same Time of Day (ToD) clock, such as the coordinated universal time (UTC) clock. It is also envisaged that radio network systems may be used as a resilient timing source for end users, e.g. as a backup or an alternative to GPS/GNSS-based solutions.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

In a first aspect, this specification describes apparatus (which may be or may be a component of a mobile device) comprising means for: estimating a propagation delay of transmissions between a base station and a mobile device, based on data from at least one motion sensor that is local to the mobile device; determining updated timing information based on the estimated propagation delay; and updating an internal clock of the mobile device in accordance with the updated timing information. In some examples, the means are configured for using the updated timing information for determining timings of uplink transmissions and/or for determining timings of downlink transmissions from the base station. The estimated propagation delay may, for instance, be based on an initial propagation delay and a change in the propagation delay resulting from motion of the mobile device. The updated timing information may be based on the estimated propagation delay and reference time information received from the base station.

The means may be further configured for: determining whether the estimated propagation delay is valid and/or sufficiently accurate; and updating the internal clock of the mobile device in accordance with the updated timing information, based on a determination that the estimated propagation delay is valid and/or sufficiently accurate. The means may be further configured for: based on a determination that the estimated propagation delay is not valid and/or is not sufficiently accurate, transitioning the mobile device out of a sensor-based timing synchronisation mode in which the propagation delay is estimated based on data from at least one motion sensor that is local to a mobile device. Prior to transitioning to the sensor-based timing synchronisation mode and also having transitioned out of the sensor-based timing synchronisation mode, the means may determine the propagation delay based on transmissions exchanged between the base station and the mobile device, and not based on data from at least one motion sensor that is local to a mobile device.

In some examples, determining whether the estimated propagation delay is valid and/or sufficiently accurate may comprise determining whether a duration of time for which the mobile device has been in the sensor-based timing synchronisation mode exceeds a time threshold. In such examples, the means are further configured for transitioning out of the sensor-based timing synchronisation mode based on a determination that the duration of time for which the mobile device has been in the sensor-based timing synchronisation mode exceeds the time threshold. The time threshold may for instance be indicated in information received from the base station. In addition or alternatively, the time threshold may correspond to a duration for which it is determined that estimating the propagation delay, based on the data from the at least one motion sensor that is local to a mobile device, will remain above a minimum accuracy.

In some examples, determining whether the estimated propagation delay is valid and/or sufficiently accurate may comprise determining whether the estimated propagation delay is less accurate than a threshold accuracy. In such examples, the means may be further configured for transitioning out of the sensor-based timing synchronisation mode based on a determination that the estimated propagation delay is less accurate than the threshold accuracy. Determining whether the estimated propagation delay is less accurate than the threshold accuracy may comprise comparing an expected time of arrival at the mobile device of a transmission from the base station with a measured time of arrival of the transmission, wherein the expected time of arrival was estimated based on the estimated propagation delay, and determining that the estimated propagation delay is less accurate than the threshold accuracy when the difference between the measured time of arrival and the expected time of arrival is greater than a threshold difference.

The means may be further configured for, when the mobile device is operating in a sensor-based timing synchronisation mode in which the propagation delay is estimated based on data from at least one motion sensor that is local to a mobile device: monitoring and/or receiving downlink transmissions from the base station less often than when not operating in the sensor-based timing synchronisation mode; and/or suspending uplink transmissions from the mobile device to the base station or causing fewer uplink transmissions than when not operating in the sensor-based timing synchronisation mode.

The means may be further configured for determining to transition the mobile device into a sensor-based timing synchronisation mode in which the propagation delay is estimated based on data from at least one motion sensor that is local to a mobile device based on: a determination that the mobile device should reduce power usage; or a determination that an ability to exchange transmissions with the base station has become or is expected to become less reliable; or a determination that the mobile device is, or will be, handing over from being served by the base station to being served by another base station.

In a second aspect, this specification describes apparatus comprising means for causing transmission, from a mobile device to a base station, of a message which indicates to the base station that the mobile device is capable of operating in a sensor-based timing synchronisation mode in which the mobile device determines updated timing information for use by the mobile device based on an estimated propagation delay of transmissions between the base station and the mobile device that is estimated based on data from at least one motion sensor that is local to a mobile device. The apparatus of the second aspect may be, or may be a component of, a mobile device (or UE). In some examples, the message may be UE capability report or a message which carries UE assistance information.

The message, or a subsequent message transmitted from the mobile device to the base station, may indicate an intent of the mobile device, or request permission, to transition into the sensor-based timing synchronisation mode.

The message or the subsequent message may include at least one of: information indicative of a maximum duration for which the mobile device will remain in the sensor-based timing synchronisation mode before transitioning out of the sensor-based timing synchronisation mode; and information indicative of an estimated accuracy for the updated timing information, when the mobile device is operating in the sensor-based timing synchronisation mode.

The means of the second aspect may be further configured to, following transmission of the message which indicates to the base station that the mobile device is capable of operating in the sensor-based timing synchronisation mode: receive timing synchronisation parameters from the base station indicative of downlink signal timings for use by the mobile device when operating in the sensor-based timing synchronisation mode; and/or receive, from the base station, an instruction to transition to operating in the sensor-based timing synchronisation mode.

In a third aspect, this specification describes apparatus comprising means for: responding to a determination by a base station that a mobile device has transitioned into a sensor-based timing synchronisation mode, in which the mobile device determines updated timing information for use by the mobile device based on a propagation delay of transmissions between the base station and the mobile device that is estimated based on data from at least one motion sensor that is local to a mobile device, by reducing a frequency with which the base station monitors for incoming transmissions from the mobile device, and/or reducing a frequency with which transmissions from the base station to the mobile device are sent. The apparatus of the third aspect may additionally or alternatively comprise means for responding to receipt by a/the base station of a message from a/the mobile device, that indicates an ability of the mobile device to operate in a sensor-based timing synchronisation mode in which the mobile device determines updated timing information for use by the mobile device based on a propagation delay of transmissions between the base station and the mobile device that is estimated based on data from at least one motion sensor that is local to a mobile device, by determining timing synchronisation parameters for communications with the mobile device and causing transmission to the mobile device of information, for use by the mobile device in configuring communications with the base station, indicative of at least some of the timing synchronisation parameters. The determination by the base station that a mobile device has transitioned into a sensor-based timing synchronisation mode may be based on an indication received from the mobile device, or a transmission of an instruction by the base station for causing the mobile device to transition. The apparatus of the third aspect may be, or may be a component of, a base station.

In a fourth aspect, this specification describes a method comprising: based on data from at least one motion sensor that is local to a mobile device, estimating a propagation delay of transmissions between a base station and the mobile device; determining updated timing information based on the estimated propagation delay; and updating an internal clock of the mobile device in accordance with the updated timing information.

The method may further comprise determining whether the estimated propagation delay is valid and/or sufficiently accurate; and updating the internal clock of the mobile device in accordance with the updated timing information, based on a determination that the estimated propagation delay is valid and/or sufficiently accurate. The method may further comprise: based on a determination that the estimated propagation delay is not valid and/or is not sufficiently accurate, transitioning the mobile device out of a sensor-based timing synchronisation mode in which the propagation delay is estimated based on data from at least one motion sensor that is local to a mobile device.

In some examples, determining whether the estimated propagation delay is valid and/or sufficiently accurate may comprise determining whether a duration of time for which the mobile device has been in the sensor-based timing synchronisation mode exceeds a time threshold. In such examples, the method may comprise transitioning out of the sensor-based timing synchronisation mode based on a determination that the duration of time for which the mobile device has been in the sensor-based timing synchronisation mode exceeds the time threshold.

In some examples, the method may comprise determining whether the estimated propagation delay is valid and/or sufficiently accurate comprises determining whether the estimated propagation delay is less accurate than a threshold accuracy. In such examples, the method may comprise transitioning out of the sensor-based timing synchronisation mode based on a determination that the estimated propagation delay is less accurate than the threshold accuracy.

The method of the fourth aspect may further comprise any of the operations described in connection with the apparatus of the first aspect.

In a fifth aspect, this specification describes a method comprising causing transmission, from a mobile device to a base station, of a message which indicates to the base station that the mobile device is capable of operating in a sensor-based timing synchronisation mode in which the mobile device determines updated timing information for use by the mobile device based on an estimated propagation delay of transmissions between the base station and the mobile device that is estimated based on data from at least one motion sensor that is local to a mobile device. The method of the fifth aspect may further comprise any of the operations described in relation to the apparatus of the second aspect.

In a sixth aspect, this specification describes a method comprising responding to a determination by a base station that a mobile device has transitioned into a sensor-based timing synchronisation mode, in which the mobile device determines updated timing information for use by the mobile device based on a propagation delay of transmissions between the base station and the mobile device that is estimated based on data from at least one motion sensor that is local to a mobile device, by reducing a frequency with which the base station monitors for incoming transmissions from the mobile device, and/or reducing a frequency with which transmissions from the base station to the mobile device are sent.

In a seventh aspect, this specification describes computer-readable instructions which, when executed by computing apparatus, cause the computing apparatus to perform the method of any one of the fourth to sixth aspects.

In an eighth aspect, there is provided a non-transitory computer readable medium comprising program instructions stored thereon for performing any of the operations described in relation to the apparatuses of any one of first to third aspects.

In a ninth aspect, there is provided a computer program product comprising a set of instructions which, when executed on an apparatus, cause performance of any of the operations described in relation to the apparatuses of any one of first to third aspects.

In a tenth aspect, there is provided an apparatus comprising: at least one processor; and at least one memory including computer program code which, when executed by the at least one processor, causes the apparatus to: estimate a propagation delay of transmissions between a base station and a mobile device, based on data from at least one motion sensor that is local to the mobile device; determine updated timing information based on the estimated propagation delay; and update an internal clock of the mobile device in accordance with the updated timing information. The program instructions may cause performance of any operation described in connection with the apparatus of the first aspect.

In an eleventh aspect, there is provided an apparatus comprising: at least one processor; and at least one memory including computer program code which, when executed by the at least one processor, causes the apparatus to: cause transmission, from a mobile device to a base station, of a message which indicates to the base station that the mobile device is capable of operating in a sensor-based timing synchronisation mode in which the mobile device determines updated timing information for use by the mobile device based on an estimated propagation delay of transmissions between the base station and the mobile device that is estimated based on data from at least one motion sensor that is local to a mobile device. The program instructions may cause performance of any operation described in connection with the apparatus of the second aspect.

In a twelfth aspect, there is provided an apparatus comprising: at least one processor; and at least one memory including computer program code which, when executed by the at least one processor, causes the apparatus to: respond to a determination by a base station that a mobile device has transitioned into a sensor-based timing synchronisation mode, in which the mobile device determines updated timing information for use by the mobile device based on a propagation delay of transmissions between the base station and the mobile device that is estimated based on data from at least one motion sensor that is local to a mobile device, by reducing a frequency with which the base station monitors for incoming transmissions from the mobile device, and/or by reducing a frequency with which transmissions from the base station to the mobile device are sent.

### BRIEF DESCRIPTION OF THE FIGURES

Example embodiments will now be described by way of non-limiting example, with reference to the accompanying drawings, in which:

FIG. 1A is an illustration of an exchange of messages via which a mobile device may determine a propagation delay from a base station to the mobile device;

FIG. 1B is an illustration of another exchange of messages via which a mobile device may determine a propagation delay from a base station to the mobile device;

FIG. 0.2 illustrates the concept of propagation delay;

FIG. 3 illustrates sources of timing synchronisation errors between a base station and a mobile device;

FIG. 4 is a schematic illustration of an example of propagation delay estimation based on movement of a mobile device;

FIG. 5 is a flow chart illustrating various examples operations, at least some of which may be performed by or for a mobile device;

FIG. 6 illustrates an example of propagation delay estimation based on accelerometer data;

FIG. 7 is a message flow illustrating various example operations which may be performed by or for a mobile device and a base station;

FIG. 8 illustrates power savings which may be obtained by mobile devices operating in accordance with various examples described herein;

FIG. 9 is a schematic view of an example configuration for a mobile device which may be configured to perform various operations described herein;

FIG. 10 is a schematic view of an example configuration for a base station which may be configured to perform various operations described herein; and

FIG. 11 is a non-transitory medium that may comprise code or data according to some example embodiments.

### DETAILED DESCRIPTION

Example embodiments relate to performance of propagation delay estimation based on data from at least one motion sensor that is local to a mobile device. As will become clear from the below description, such embodiments may provide power usage and radio resource savings in radio networks such as, but not limited to, 5G networks.

Due to the dynamic nature of radio links, it may be beneficial to deliver time synchronization from base stations (which may be referred to as Node Bs, eNodeBs, eNBs, or gNBs) to UEs (user equipment, which may be referred to herein as mobile devices) over UMTS air interfaces (or “Uu interfaces”). In 5G networks, using the 5G NR control plane, time synchronization information (i.e. gNB/base station time) may currently be delivered from a gNB to served UEs via one of two approaches. The first approach is a broadcast method in which reference time information (RTI, e.g. referenceTimelnfo-r16) is encoded in a broadcast message (e.g. a system information block, such as a “SIB9”, message). The second approach is a unicast method in which the time information is encoded e.g. in a unicast radio resource control (RRC) message. In both approaches, the encoded time information is the base station's clock time, which corresponds to an ending boundary of a specific radio system frame (refSFN), where the specific radio system frame is indicated to the UE either implicitly (in case of the broadcast approach) or explicitly (in the case of the unicast approach). When a UE receives the broadcast or unicast message, it associates the time information with its own specific radio system frame boundary, which is aligned with the base station's specific radio system frame boundary. In this way, underlying radio frame timing at the base station and the UE may be used as a common reference for delivery of time of day information.

A challenge in using the underlying radio frame timing at the base station and UE as a common reference for delivery of time of day information is that radio frame boundaries (e.g. the specific radio system frame boundaries) at the base station and UE may not be aligned in time with respect to one another. For instance, a downlink frame boundary at the UE is shifted by the propagation delay (PD). The propagation delay is the time it takes for the radio frame to propagate from the base station to the UE over the air, with respect to the corresponding frame boundary at the base station. When a UE synchronizes its clock timing by associating time information carried by the broadcast or unicast message with its own specific radio system frame boundary, the UE's understanding of the time of day will be delayed by the propagation delay as compared to the base station's time of day. This may not be an issue if the propagation delay is relatively small compared to a maximum allowed timing error. However, a maximum synchronization error over 5G RAN is, in Release 17, limited to less than 900 ns (or 450 ns for Uu interfaces in a control-to-control scenario), and this may potentially be reduced down to e.g. 250 ns in future releases. Since every 10 m of distance adds 33.3 ns of propagation delay, it is therefore not inconceivable that a UE's distance from the base station may be such that the propagation delay alone introduces an error that is larger than the maximum allowance. Mechanisms for compensating for this timing error are therefore needed.

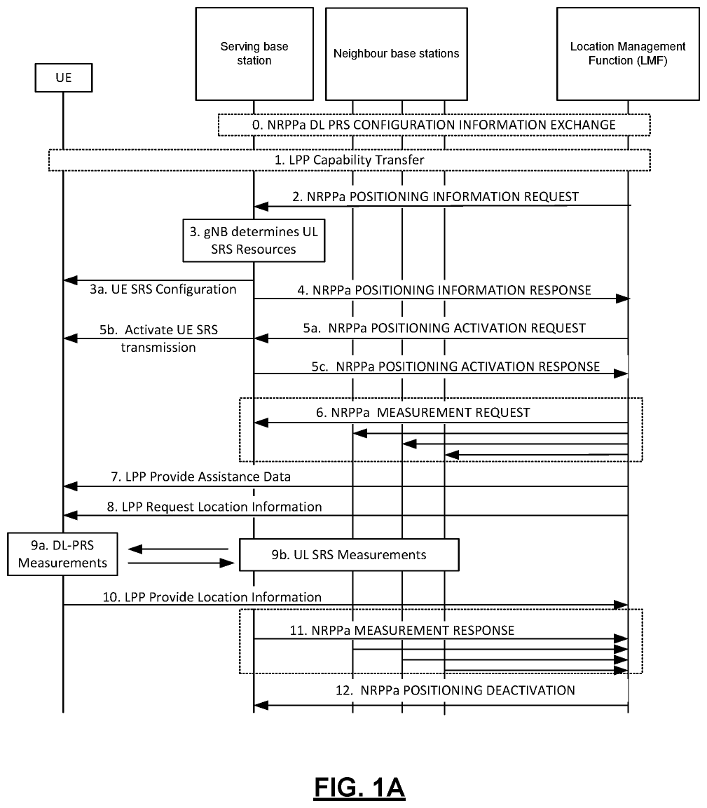

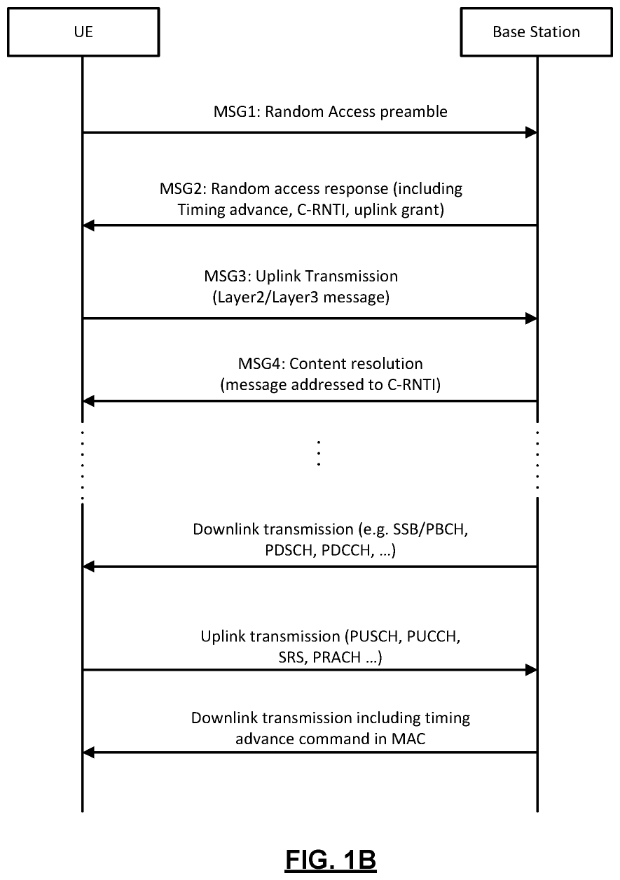

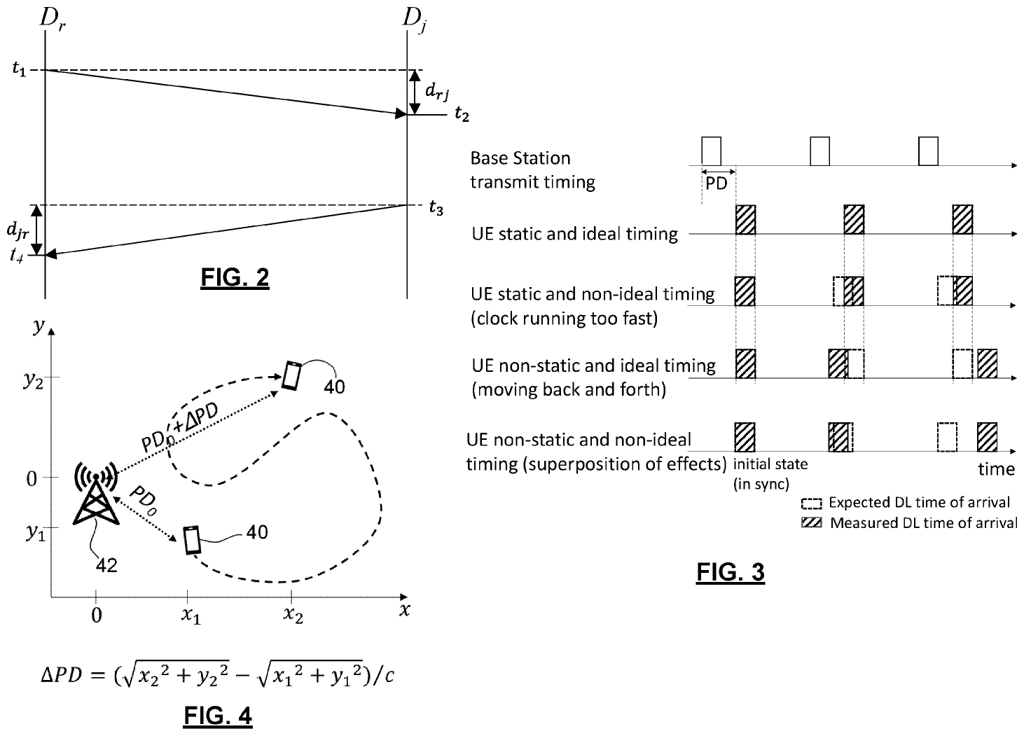

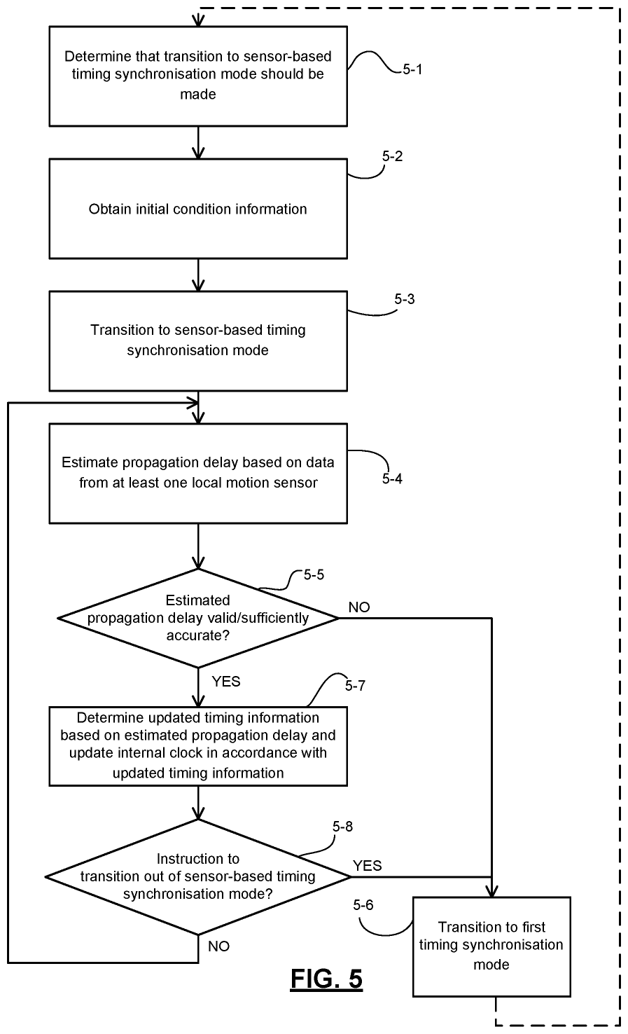

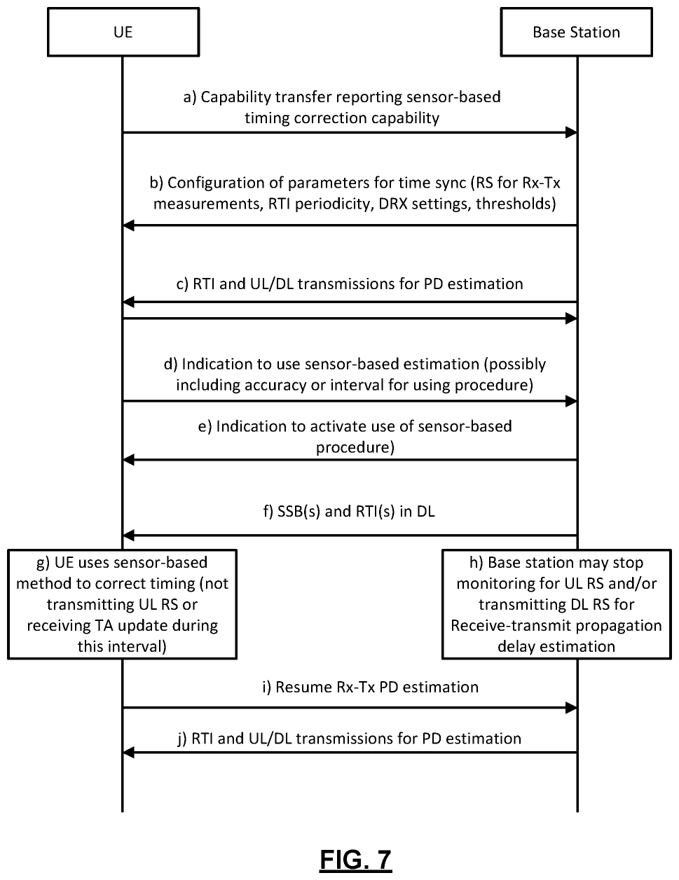

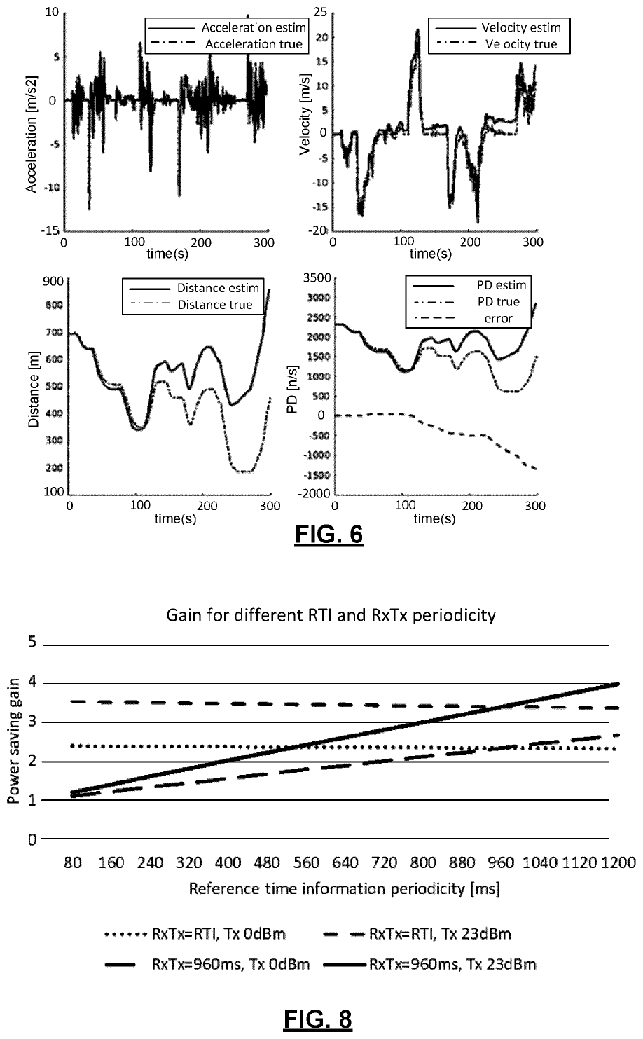

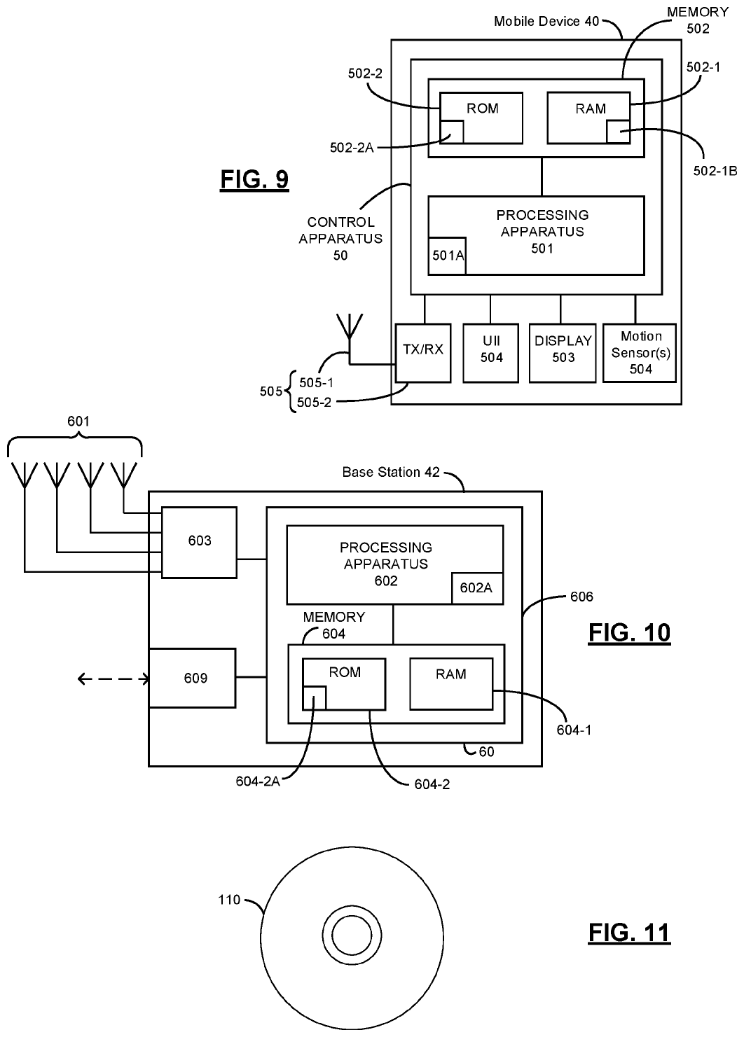

UEs are currently configured to compensate the time information received in the aforementioned broadcast or unicast messages so as to take into account the propagation delay. The propagation delay may be determined by way of transmissions between the UE and the base station. More specifically, a measurement of the propagation delay may be estimated from a Receiver-Transmitter (Rx-Tx) round trip time (RTT) measurement. This may be obtained by the UE through performance of so-called “multi-RTT” measurements, which may be performed as part of the positioning framework. Example procedures through which the multi-RTT measurements may be performed are illustrated in FIG. 1A. Such procedures may be referred to herein as “RTT” procedures. As can be seen from FIG. 1A, in such a procedure and as part of a positioning determination, the UE may be configured to measure time of arrival of downlink reference signals (RS) from its serving base station, while the base station may be configured to measure a time of arrival of uplink reference signal transmissions from the UE.

Alternatively, the estimated propagation delay may be determined based on a timing advance (TA) information (or a TA command) that is communicated from the base station to the UE. The timing advance information indicates by how much a UE's uplink transmission should be advanced relative to the downlink reception time. Example procedures by which timing advance information may be communicated to from the base station to the UE are illustrated in FIG. 1B. Such procedures may be referred to herein as “TA” procedures. In such procedures, the UE may receive the TA information/command from the base station during the random access procedure or after any uplink transmission, e.g. via MAC message.

The simplest current approximation of the downlink propagation delay is RTT/2 or TA/2. This is based on the assumption that there are symmetric delays in the uplink (UL, that is for communication from UE to base station) and downlink (DL, that is for communication from base station to UE) directions.

FIG. 2 illustrates the basic principle of time synchronisation between network entities, such as, but not limited to, a mobile device and a base station. The illustrated principle applies equally to TA or RTT. More specifically FIG. 2, illustrates transmission of two signals: a first signal transmitted at time t₁ from a first network entity Dᵣ and received at a second network entity Dⱼ at time t₂, and a second signal transmitted from the second network entity Dⱼ at time t₃ and received at the first network entity Dᵣ at time t₄. For a time offset bⱼ from Dⱼ in relation to Dᵣ:

$${t}_{2} = {t}_{1} + {d}_{rj} + {b}_{j}$$

$${t}_{4} = {t}_{3} + {d}_{jr} - {b}_{j}$$

Assuming that the propagation delay (PD) is symmetric, dᵣⱼ=dⱼᵣ, so

$${b}_{j} = \frac{( {t}_{2} - {t}_{1} ) - ( {t}_{4} - {t}_{3} )}{2} and PD = \frac{( {t}_{2} - {t}_{1} ) + ( {t}_{4} - {t}_{3} )}{2}$$

A target clock timing (e.g. of a UE) may be synchronized to a source clock timing (e.g. of the base station) by applying the offset bⱼ to correct the current clock timing of the source clock. Alternatively, the target clock timing may be set to be equal to a source clock timing (that may, for instance, be provided by the base station, e.g. via reference time information (RTI) such as referenceTimeInfo-r16), summed with the propagation delay.

In addition to the propagation delay, there may be additional effects that affect the timing accuracy. These may include base station transmission timing errors and UE reception timing errors. These may vary based on the designs of the entities involved and may be managed in various ways. For instance, in a 5G network, gNB transmit timing error may be minimized if gNB-CU, gNB-DU and RRU are collocated, and UE receive timing error may be reduced when bandwidth is increased.

Accurate time synchronization may be dependent on the UEs capability to accurately track downlink frame timing, such as downlink time of arrival (ToA). Such capability may also depend on the availability and bandwidth of downlink reference signals provided by the base station, such as SSB or CSI-RS. It may be beneficial for the UE to be able to identify changes to the downlink frame timing, as this may indicate that the correction factor from the downlink propagation delay should be updated to maintain an accurate time of departure of uplink signals. In order to identify such changes to the downlink frame timing, the UE may compare the measured time of arrival with an expected time of arrival calculated based on its currently estimated DL frame timing, which may take into account the most-recent estimation of the propagation delay.

At least two major effects may cause mismatches between measured and expected ToA. These are 1) that UE clock timing has shifted in comparison with base station clock timing, and 2) that the distance, and consequently propagation delay, between the base station and the UE has changed as a result of movement of the UE. FIG. 3 illustrates the effects of UE movement and clock timing drift on downlink frame timing. As can be seen from FIG. 3, there may be a superposition of these two effects and, when such superposition occurs, it may not be possible for the UE to distinguish the two individual effects.

One solution for ensuring that the UE is properly able to counteract these two effects is to provide the UE with sufficiently frequent reference signals, as well as sufficiently frequent propagation delay estimations, thereby to enable the UE to perform propagation delay compensation. However, one issue with such a solution is that, with a Rx-Tx based propagation delay estimation (e.g. as shown in FIG. 2) frequent uplink and downlink signalling is required. This may result in a considerable UE power usage and radio resource usage.

The technology described herein provides methods (and apparatus which may perform or cause performance of the methods) which may allow UEs to locally compensate for a changing propagation delay resulting from UE movements. This may reduce the demand for uplink/downlink exchanges and so may result in reduced UE power usage and radio resource usage. This may be particularly beneficial for the UE when in an idle/inactive mode in which uplink traffic is otherwise kept at a minimum in order to save power. The methods described herein may also be beneficial for maintaining timing synchronization in conditions in which obtaining accurate timing from the network is challenging, for instance due to varying multipath interference, non-line-of-sight (NLOS) conditions or limited network coverage. Similarly, the methods may be beneficial as compared to obtaining the time via GPS/GNSS which may be prone to jamming/spoofing and may not be available, for example, in tunnels and indoors. In addition, use of the methods described herein may enable certain mobile devices to omit a GPS/GNSS module altogether or, put another way, may provide a back-up timing synchronisation mechanism for devices which do not have a GPS/GNSS module.

As described herein, a mobile device (or UE) is configured to estimate the propagation delay of transmissions between a base station and the mobile device, based on data from at least one motion sensor that is local to the mobile device. Then, based on the estimated propagation delay, updated timing information may be determined. Such updated timing information may be used by the mobile device for a number of purposes. For instance, an internal clock of the mobile device may adjusted on the basis of the updated timing information, the updated timing information may be used for determining downlink timing (e.g. expected ToA for downlink transmissions) and/or the updated timing information may be used for timing of uplink transmissions.

FIG. 4 illustrates an example scenario in which a mobile device 40 may perform the aforementioned methods. In FIG. 4, the mobile device 40 is initially located at a first position (x₁, y₁). When operating in a first timing synchronisation mode, the mobile device may track and receive downlink signals from a base station 42. In order to track downlink signals, the mobile device may measure the time of arrival of a downlink reference signals. Such reference signals may include but are not limited to SSB reference signals (or CSI-RS, PRS and DMRS, if such are made available by the base station).

While operating in the first timing synchronisation mode, the mobile device 40 may know, or be able to determine, its initial propagation delay, PD₀ for transmissions between the base station 42 and the mobile device 40 at its current position. The initial propagation delay may be determined using TA or RTT-based estimation as discussed above with reference to FIGS. 1A and 1B. Based on the initial propagation delay, the mobile device may determine an expected time of arrival for a particular downlink signal at the first position.

As will be discussed in more detail below, the mobile device may transition from a first timing synchronisation mode to a second (or sensor-based) timing synchronisation mode. In the sensor-based timing synchronisation mode, the mobile device 40 may be able to reduce the number of exchanges of signals with the base station. To achieve this, the mobile device is configured to estimate the propagation delay of transmissions between the base station 42 and the mobile device 40, based on data from at least one motion sensor that is local to a mobile device. More specifically, when the mobile device 40 moves away from its first (or initial) position, x₁,y₁, its movement is tracked by the at least one motion sensor local to (e.g. integral, or otherwise co-located, with) the mobile device. Based on data from the at least one motion sensor, a change in a distance between the base station 42 and the mobile device 40 can be determined. Then, based on the determined change in distance, a corresponding change in the propagation delay ΔPD can be estimated, for instance using the equation shown in FIG. 4. This change in propagation delay may then be used along with the initial propagation delay, PD₀ for determining updated timing information.

In some examples, the mobile device may perform a determination as to whether the sensor-based estimation of the propagation delay is still valid and/or a determination as to whether the sensor-based estimation of the propagation delay is sufficiently accurate. This may be performed, for instance, prior to adjusting an internal clock of the mobile device sensor-based estimation of the propagation delay

To determine validity, the mobile device may, for instance, compare a time of a most recent sensor-based propagation delay estimate against a time at which the most recent non-sensor based propagation delay estimate was performed. If the difference is in excess of a threshold, the most recent sensor-based propagation delay estimate may be considered invalid. Put another way, the mobile device may determine a duration for which the mobile device has been operating in the sensor-based timing synchronisation mode, and may compare that duration against a threshold. The threshold may be representative of a maximum time interval for which sensor-based estimation can be relied upon as being sufficiently accurate.

To determine whether the most-recent sensor-based propagation delay estimation is sufficiently accurate, the mobile device may use the most-recent sensor-based propagation delay estimation to determine an adjusted expected time of arrival (e.g. scheduled DL transmission time+PDₒ+ΔPD). This adjusted expected time of arrival may then be compared against an actual, measured time of arrival for the DL transmission, with the difference between the adjusted expected and measured times of arrival being compared against a threshold. If the difference exceeds the threshold, the sensor-based estimation may be deemed to be not sufficiently accurate.

In response to determining that the sensor-based estimation is no longer valid and/or sufficiently accurate, the mobile device may revert to a synchronization procedure in which propagation delay is determined based on the exchange with the base station of one or multiple uplink and downlink transmissions. Such procedures may for instance be those discussed with reference to FIGS. 1A and 1B. This reversion may also be considered a transitioning out of the sensor-based timing synchronisation mode to the first timing synchronisation mode. In some implementations, a duration for which the mobile device remains in the first timing synchronisation mode may be dependent on a current power saving mode of the mobile device. For instance, if the mobile device is in a power saving mode (e.g. RRC_INACTIVE), it may remain in the first timing synchronisation mode for less time before transitioning back the sensor-based timing synchronisation mode than if the mobile device is not in a power saving mode. In some examples, the mobile device may remain in the first timing synchronisation mode long enough to obtain a more accurate measure of the propagation delay. The mobile device may then transition back to the sensor-based timing synchronisation mode responsive to having obtained a more accurate measure of the propagation delay via signal exchanges with the base station.

In some implementations, the mobile device 40 may be configured to adjust an internal clock timing based on the sensor-based estimation of the propagation delay. In some examples, this may be performed in response to the determination that the estimation is valid and/or is sufficiently accurate. This may be performed, for instance, by using the sensor-based estimation of the propagation delay to adjust reference time information (RTI) that is received in a downlink transmission from the base station, and setting the internal clock accordingly. For instance, the mobile device may adjust the internal clock to RTI+PD₀+ΔPD.

FIG. 5 illustrates various operations which may be performed by a mobile device (or a controller or processing apparatus of a mobile device).

As discussed above, the mobile device may be configured to transition between first and second timing synchronisation modes. In the first timing synchronisation mode, the mobile device may use one or more propagation delay determination methods (such as those depicted in FIGS. 1A and 1B) which do not estimate the propagation delay based on data from at least one motion sensor that is local to the mobile device. In the second timing synchronisation mode, which may be referred to as a sensor-based timing synchronisation mode, the mobile device may determine updated timing information based on data from at least one motion sensor that is local to a mobile device.

In some implementations described herein, in the second timing synchronisation mode, sensor-based estimation may be used in conjunction with a determination of the propagation delay based on exchange of signals with the base station (e.g. as in FIGS. 1A and 1B). In such implementations, the exchange of signals with the base station may be performed less frequently when compared with exchange of such signals when the device is operating in the first timing synchronisation mode.

In operation 5-1 of FIG. 5, the mobile device determines that a transition from the first timing synchronisation mode to the sensor-based timing synchronisation mode should be made. Such a determination may be made in response to an indication or instruction received from the base station. Additionally or alternatively, the mobile device may be configured to make the determination of operation 5-1 without such an instruction/indication. For instance, in some examples, the mobile device may make the determination autonomously but may indicate this to the base station which then sends a message permitting or instructing the mobile device to make the transition.

The mobile device may determine that it should make the transition based on a number of factors. For instance, it may be made based on a determination that the mobile device should save power and/or reduce uplink/downlink exchanges with the base station. In addition or alternatively, the determination to transition into the sensor-based timing synchronisation mode may be made in response to determining that the mobile device is entering or has entered an area of unreliable network coverage in which the ability to exchange uplink and downlink signals may be inconsistent. In addition or alternatively, the mobile device may be configured to determine to transition to the sensor-based timing synchronisation mode responsive to determining that there is no user plane data to be exchanged. The UE may also respond to such a determination by entering into a power saving mode (e.g. RRC_INACTIVE).

In addition or alternatively to the above, the mobile device may be configured to transition to the sensor-based timing synchronisation mode during a handover procedure. During a handover procedure, when the mobile device is moving from being served by a source base station to being served by a target base station, there may be an interruption in the connection with the source base station. As a consequence, it may not be possible to obtain PD estimation relative to source base station via the usual methods (TA-based or RTT-based). As such, the device may transition to the sensor-based timing synchronisation mode in order to perform corrections to the propagation delay (and so keep its internal clock properly synchronised) until handover procedure is concluded.

In some examples, in response to the determination that the mobile device is to transition to the sensor-based timing synchronisation mode, at least one local motion sensor that is used in the sensor-based timing synchronisation mode may be woken from a sleep mode (if required).

In operation 5-2 of FIG. 5, prior to transitioning to the sensor-based timing synchronisation mode, the mobile device may, in some examples, obtain initial condition information. This initial condition information may include one or both of reference time information and the initial propagation delay. In some examples, the mobile device may simply wait to receive the initial condition information from base station (or at least signals from which the initial condition information can be determined, e.g. as described with reference to FIGS. 1A and 1B). In addition or alternatively, the mobile device may proactively obtain some or all of the information, e.g. by requesting or otherwise causing the information or signals for enabling determination of the information to be transmitted from the base station. In some examples, the initial condition information may include a current location of the mobile device. The current location of the mobile device may, for instance, be determined using the 3GPP positioning framework (e.g. as defined in (TS38.305)) based on measurements of time of arrival and angle of arrival (AoA) from different cells/base stations assuming the mobile device knows the position of the cells/base stations. Alternatively, the current location may be determined based on knowledge of the initial propagation delay and a direction to its serving base station, or in any other suitable manner (e.g. using GPS or GNSS). The current location of the mobile device relative to the base station may allow the mobile device to determine, using motion sensor data, whether motion of the mobile device is towards or away from the base station. This may allow the mobile device to determine the change in propagation delay as discussed below.

In examples in which the mobile device is transitioning to the sensor-based timing synchronisation mode responsive to determination of a handover from a source base station to a target base station, the mobile device may, for example, obtain initial condition information (e.g. initial propagation delay and current location) relative to source and/or target base stations, and keep track of downlink signals carrying timing information (e.g. SIB9) from one or both. This may be possible during handover as the mobile device does not need to have a connection established to read timing information from e.g. an SIB9 message. The mobile device may therefore operate in sensor-based timing synchronisation mode (as described herein) to keep its internal clock synchronised during the handover procedure.

In operation 5-3, the mobile device transitions to the sensor-based timing synchronisation mode. In this mode, the mobile device may reduce the frequency of transmissions to the base station and/or the frequency of periods in which it monitors for transmissions from the base station. For instance, the mobile device may not participate in any receive-transmit (Rx-Tx) signalling exchanges. As such, in some implementations, the mobile device operating in the sensor-based timing synchronisation mode may not transmit uplink reference signals and may not receive timing advance updates. Similarly, the mobile device may suspend participation in the multi-RRT procedures, such as that described with reference to FIG. 1A. It will be appreciated, however, that certain downlink reference signals may still be tracked when operating in the sensor-based timing synchronisation mode. These may include, for instance, the downlink signals which include reference time information and/or downlink synchronization signal block (SSB) signals. Nonetheless, the overall amount of mobile device-base station communication may be significantly reduced, thereby resulting in a significant power saving for the mobile device while it is operating in the sensor-based timing synchronisation mode.

In some implementations, even for those types of reference signals that are received by the mobile device when operating in the sensor-based timing synchronisation mode, the mobile device might not monitor for and/or receive all such signals. Instead, the mobile device may monitor for and/or receive a subset of such signals. For instance, if the base station transmits a particular reference signal (e.g. RTI in SIB9) with a particular frequency, the mobile device may receive those signals with a lower frequency. For instance, one in ten such signals may be received. In other examples, all such signals may be received, but the mobile device may use a subset of the signals for determining the updated timing information. For instance, for RTI-carrying reference signals, the mobile device may determine updated timing information for a subset of them. For instance, if the signals are being tracked with a periodicity of 160 ms, the mobile device may determine updated timing information using those signals and the motion sensor data with a periodicity of 1600 ms. Both of the above examples may be beneficial, for instance for reducing computation and/or reducing energy spend with sensor signal acquisition. In addition, it may provide more time to improve sensor-based estimation accuracy between measurements (e.g. by filtering, combining sensor signals, signal processing, and/or other means).

In operation 5-4, the mobile device uses data from at least one motion sensor that is local to the device to estimate the propagation delay. The mobile device may additionally use the initial condition information obtained in operation 5-3.

Firstly, in operation 5-4, the mobile device may use data from at least one local sensor to determine the relative distance between the mobile device and the base station. The local sensors may include one or any combination of various different inertia measurement units (IMUs) including accelerometer, gyroscope; magnetometer; absolute orientation sensors; level sensors; altimeters; barometric pressure sensors; gravimeters; light detection and ranging (LiDAR) sensors; radar; ambient light sensors; proximity sensors; ultrasonic sensor; microelectromechanical (MEMS) and nanoelectromechanical systems (NEMS). Since movement towards or away from the base station may be relevant for determining the propagation delay, the sensor (or combination of sensors) may be configured to track movement in all directions and the mobile device rotation so as to maintain awareness of distance between the base station and the mobile device. The determination of the relative distance between the mobile device and the base station based on the local sensors may be performed in any suitable manner. For instance, various approaches are described in the following documents:
1. 3GPP TS38.305, Stage 2 functional specification of User Equipment (UE) positioning in NG-RAN, (including diverse positioning methods for NR such as Multi-RTT, beacons, Bluetooth, WLAN, motion sensor, GNSS, barometric sensor, DL/UL-TDOA, etc.)
2. B. Barshan and H. F. Durrant-Whyte, “Inertial navigation systems for mobile robots,” in IEEE Transactions on Robotics and Automation, vol. 11, no. 3, pp. 328-342, June 1995, doi: 10.1109/70.388775.
3. H. H. S. Liu and G. K. H. Pang, “Accelerometer for mobile robot positioning,” in IEEE Transactions on Industry Applications, vol. 37, no. 3, pp. 812-819, May-June 2001, doi: 10.1109/28.924763.
4. R. Harle, “A Survey of Indoor Inertial Positioning Systems for Pedestrians,” in IEEE Communications Surveys & Tutorials, vol. 15, no. 3, pp. 1281-1293, Third Quarter 2013, doi: 10.1109/SURV.2012.121912.00075
5. H. Chen, P. Aggarwal, T. M. Taha and V. P. Chodavarapu, “Improving Inertial Sensor by Reducing Errors using Deep Learning Methodology,” NAECON 2018 —IEEE National Aerospace and Electronics Conference, 2018, pp. 197-202, doi: 10.1109/NAECON.2018.8556718.
6. A. Poulose, O. S. Eyobu and D. S. Han, “An Indoor Position-Estimation Algorithm Using Smartphone IMU Sensor Data,” in IEEEAccess, vol. 7, pp. 11165-11177, 2019, doi: 10.1109/ACCESS.2019.2891942.

In one simple example implementation, acceleration measurements d from accelerometer may be numerically integrated (e.g. by Simpson's rule) to estimate velocity \vec{v} which can then be integrated to determine change of positioning. The change of positioning can be then converted to change of distance d between mobile device and base station.

Having determined the change in distance between the mobile device and base station, may then be then converted into a change in propagation delay, for instance by dividing the change in distance between the mobile device and base station by the speed of light c, i.e. PD=d/c.

The current propagation delay may then be estimated based on the initial propagation delay (e.g. as obtained in operation 5-2) and the change in the propagation delay that is estimated based on the local motion sensor data.

A one-dimensional illustrative example of how accelerometer data can be converted to an estimated propagation delay is shown in FIG. 6, which also shows how the associated error changes with time. To obtain the curves illustrated in FIG. 6, the accelerometer was modelled with a first order error of 10%, an unfiltered sensor signal with signal-to-noise ratio of 20 dB, and a clock timing error of 1 ppm (which is included as error in integration interval). Due to error accumulation, the error in the estimated propagation delay tends to increase with time and, in the example of FIG. 6, it can be seen that the magnitude of propagation delay estimation error is above 500 ns after 200 seconds.

Lower errors are of course achievable if more sophisticated approaches are used. Such approaches may include sensor fusion, Kalman filters and machine learning techniques. Location estimation may also be enhanced by measurement of beacon signals for instance from WLAN access points, Bluetooth beacons, etc.

It is described above that the propagation delay may be determined by summing the initial propagation delay with an estimated change in propagation delay. However, in some implementations, the propagation delay may be determined based on an initial distance from the base station to the mobile device and an estimated change in the distance (e.g. by dividing the new distance, that is the initial distance plus the change in distance, by the speed of light).

Next in operation 5-5, the mobile device may determine whether the estimated propagation delay is valid and/or sufficiently accurate. For instance, the mobile device may use a pre-defined interval (or time) threshold. This interval threshold may set a limit on the duration for which the mobile device can continue to estimate the propagation delay based on data from at least one local sensor without reverting to a determination of the propagation delay via an exchange of signals with the base station. If it is determined that the interval threshold has been exceeded, the propagation delay may not be considered valid. In such a case, the mobile device may proceed to operation 5-6, in which it stops performing sensor-based estimation and reverts to operation in the first timing synchronisation mode in which the propagation delay is determined via an exchange of signals with the base station. In some examples, the interval threshold may be in the range of 60 to 120 seconds. The interval/time threshold may be representative of a maximum duration for which sensor-based estimation can be relied upon as being sufficiently accurate.

As described above, to determine validity (i.e. if the estimated propagation delay is valid or if the estimated propagation delay is not valid), the mobile device may, for instance, compare a time of a most recent sensor-based propagation delay estimate against a time at which the most recent non-sensor based propagation delay estimate was performed. If the difference is in excess of the threshold, the most recent sensor-based propagation delay estimate may be considered invalid. Put another way, the mobile device may determine a duration for which the mobile device has been operating in the sensor-based timing synchronisation mode, and may compare that duration against the threshold.

In some examples, the mobile device may use an accuracy threshold to determine whether the estimated propagation delay is sufficiently accurate. The accuracy threshold may, for instance, be based on knowledge of its clock characteristics and expected timing error (e.g. statistical knowledge, or maximum expected deviation during a period, or error in ppm), and/or any other type of error, such as expected base station transmit timing error and UE DL reception timing error. As discussed above, if an expected downlink time of arrival for a downlink signal, that is determined using the propagation delay estimated in operation 5-4, is found to differ from the actual measured DL time of arrival by more than an accuracy threshold, it may be determined that the estimated propagation delay is not sufficiently accurate. In response to such a determination, the mobile device may proceed to operation 5-6, in which it stops performing sensor-based estimation and reverts to operation in the first timing synchronisation mode in which the propagation delay is determined via an exchange of signals with the base station. As an example, for a clock accuracy of 1 PPM, the maximum expected error after is 1 s 1 μs. In such an example, the threshold accuracy may be set such that, if the measured time of arrival differs from the expected time of arrival (determined using the estimated propagation delay) is greater than 1 us, the estimated propagation delay may not be considered sufficiently accurate. It should be noted that, the 1 μs threshold is based on an expectation, which may also be wrong, for example if mobile device clock has in fact drifted more than expected during the interval.

In some examples, the time/interval threshold and/or the accuracy threshold may be provided to the mobile device by the base station.

In some implementations, the mobile device may utilise both a time/interval threshold and an accuracy threshold. In such implementations, the comparisons with both of the respective thresholds may be made following the estimation of the propagation delay in operation 5-4. Alternatively, for determining validity, the mobile device may simply operate a timer, which is started when the mobile device transitions to the sensor-based timing synchronisation mode. Once the timer reaches the time/interval threshold, the mobile device may revert back to the first timing synchronisation mode (e.g. regardless of when the propagation delay estimation of operation 5-4 was last performed). In such an example, the comparison with the accuracy threshold may still be made following the estimation of the propagation delay based on the local motion sensor data in operation 5-4.

In response to a positive determination in operation 5-5, e.g. that the estimated propagation delay is valid and/or sufficiently accurate, the mobile device may proceed to operation 5-7. In operation 5-7, the mobile device may determine updated timing information based on the estimated propagation delay. Determining updated timing information may include applying a timing correction, based on the estimated propagation delay, to received reference time information (e.g. 5G system time). For instance, the updated timing information may comprise a time indicated by the received reference time information summed with the estimated propagation delay. In some examples, therefore, the updated timing information may be referred to as corrected reference time information.

The mobile device then updates an internal clock of the mobile device in accordance with the updated timing information. Put another way, the internal clock may be updated/adjusted based on the received reference time information and the estimated propagation delay (e.g. based on the received RTI summed with the estimated propagation delay). In some implementations, the time of the updated/adjusted internal clock may then be made available to a device-side time sensitive networking (TSN) translator (DS-TT) which may adjust the TSN clock accordingly. For instance, the time of the adjusted internal clock may be forwarded to at least one “end station” for synchronizing the end station with 5G system clock (in relation to this, see e.g. TS 23.501, sect 5.27.1).

In some implementations, operations 5-5 and 5-7 may be performed based on a particular downlink reference signal, for instance an RTI-carrying reference signal, being received by the mobile device. For instance, the accuracy may be determined in operation 5-5 based on the time of receipt of the signal and the internal clock may be updated based on the RTI. In such implementations, operation 5-4 may be performed periodically in anticipation of such a signal being transmitted by the base station. As mentioned above, operations 5-4, 5-5 and 5-7 may be performed for a subset of the reference signals of the particular type that are transmitted by the base station. For instance, for some instances of transmission of those reference signals, which may or may not be monitored for/received by the mobile device, operations 5-4, 5-5 and 5-7 may not be performed. This may reduce computation and/or energy spend with sensor signal acquisition. In addition, it may provide more time to improve sensor-based estimation accuracy between measurements (e.g. by filtering, combining sensor signals, signal processing, and/or other means).

Although FIG. 5 shows the updated timing information being determined in response to a positive determination in operation 5-5, in some implementations the updated timing information may be determined prior to the performance of operation 5-5 and the updated timing information may be used for adjusting the internal clock of the device in response to a positive determination in operation 5-5.

In some implementations, the mobile device may additionally or alternatively use the estimated propagation delay for autonomously adjusting an uplink signal timing (e.g. for a first transmission after discontinuous reception), so that an uplink timing error is minimized or does not exceed a timing error limit ±Tₑ (see e.g. TS 38.133). In addition or alternatively, the mobile device may use the estimated propagation delay for determining an estimated time of arrival of downlink signals, and may adjust a downlink signal monitoring period accordingly.

In some implementations, when operating in the sensor-based timing synchronisation mode, the mobile may perform receive-transmit measurements for estimating the propagation delay, but may also use the sensor-based estimation in combination. This may for instance enhance propagation delay estimation. In such examples different weights may be used for each estimation (i.e., the sensor-based estimation and the receive-transmit based estimation) depending on their respective accuracies. In addition, the received-transmit measurements may be performed less frequently than is the case in first timing synchronisation mode.

In some examples, as illustrated operation 5-8, the base station may be configured to transmit an instruction to the mobile device for causing the mobile device to transition out of the sensor-based timing synchronisation mode. This may occur, for instance, if the base station determines that the mobile device has been operating in the sensor-based timing synchronisation mode for longer than a threshold duration. In such examples, the mobile device may respond to such an instruction by transitioning to the first timing synchronisation in operation 5-6.

As mentioned above, in operation 5-6, the mobile device may revert to operation in the first timing synchronisation mode in which sensor-based estimation is not used and in which the mobile device instead determines the propagation delay via signal exchanges with the base station. In scenarios in which the mobile device is in an idle or an inactive state, the mobile device may request to resume such exchanges with the base station. In scenarios in which a timing advance-based procedure (e.g. as in FIG. 1B) is used in the first timing synchronisation mode for estimation of the propagation delay, the mobile device, when reverting to the first mode, may send an uplink signal to the base station. When the mobile device is in an idle, inactive, or connected state, a PRACH (Physical Random Access Channel) uplink transmission may be used. In scenarios in which the mobile device is in an inactive or a connected state and has an available configured grant configuration (for small data transmission, when in the inactive state), the mobile device may initiate a CG PUSCH (configured grant Physical uplink Shared Channel) transmission. When in a connected state, the mobile device may send a PUCCH (Physical Uplink Control Channel) transmission, e.g. with a scheduling request, or an SRS (Sounding Reference Signal) signal if configured. Based on the timing offset of the uplink transmission relative to downlink frame boundary, the base station may provide the mobile device with timing advance (TA) command to correct the mobile device timing for subsequent uplink transmissions, and the UE may estimate the propagation delay based on TA/2.

In scenarios in which RTT-based propagation delay estimation is used (e.g. as in FIG. 1A) in the first timing synchronisation mode, the mobile device may, when reverting to the first mode, resume reception of periodic downlink reference signals (such as Positioning Reference Signals (PRS), or Channel State Information Reference Signals (CSI-RS) and transmission of reference (e.g. SRS) signals to the base station.

In some implementations, mobile device may, upon reverting to the first timing synchronisation mode, transmit assistance information (e.g. UEAssistanceInformation) to the base station. Such assistance information is intended to aid the base station in maintaining time synchronization, such as configuring delivery of RTI and/or configuring means for propagation estimation and compensation. When sending the assistance information, the mobile device may request a propagation delay estimation update from the base station. Alternatively the mobile device may include its current sensor-based propagation delay estimate in the assistance information. The base station may use the received current sensor-based propagation delay estimate to determine whether the exchange of signals for allowing the mobile device to update the propagation delay is necessary. For instance, if the mobile device's current sensor-based propagation delay estimate is still sufficiently accurate, the base station may determine that the exchange of signals is not necessary and, in some examples, may inform the mobile device that it can return to operating the sensor-based timing synchronisation mode.

In some implementations, the mobile device may remain in the first timing synchronisation mode, until it has determined a propagation delay based on signals from the base station, at which point it may revert back to the sensor-based timing synchronisation mode.

FIG. 7 is a message flow diagram illustrating various operations which may be performed by a mobile device and base station in connection with the sensor-based propagation delay estimation described herein. As will be appreciated, the various operations depicted in FIG. 7 may correspond with, or be performed in addition, to the operations described above, such as in connection with FIG. 5. It should also be appreciated that certain operations depicted in FIG. 7 may be omitted from certain implementations of the sensor-based timing synchronisation procedure described herein.

In FIG. 7, operations g) and h) illustrate operations which may be performed by the mobile device and the base station respectively, when the mobile device transitions to sensor-based timing synchronisation mode. For instance, as shown in operation g) and discussed previously, when the mobile device is in the sensor-based timing synchronisation mode, the mobile device may not transmit uplink reference signals to the base station and/or receive timing advance updates from the base station and/or exchange Rx-Tx measurement reports with the base station. Similarly, as illustrated in operation h), when the mobile device is operating in the sensor-based timing synchronisation mode, the base station may suspend monitoring for uplink reference signals and/or transmission of downlink reference signals (e.g. those including timing advance information or which are part of the exchange of Rx-TX measurement reports), which might otherwise be used for the estimation of the propagation delay. In this way, the mobile device and/or the base station may reduce power usage, and air interface signalling, when the mobile device is operating in the sensor-based timing synchronisation mode. In some examples operation h) may be performed in response to a determination by the base station that the mobile device has transitioned into the sensor-based timing synchronisation mode. Such determination may for instance be based on an indication received from the mobile device (e.g. in operation d), or a transmission of an instruction by the base station (e.g. in operation f) for causing the mobile device to make the transition.

As illustrated in FIG. 7, the mobile device may be configured to indicate to the base station its capability to perform to sensor-based timing synchronisation. For instance, this may be indicated by a capability report transmitted from the mobile device to the base station as illustrated in operation a). Alternatively, the mobile device may be configured to indicate, via UE assistance information, a holdover capability of the mobile device (e.g. that it is capable of resorting to sensor-based mode for timing correction for a certain period).

In addition or alternatively, it may be indicated via a message illustrated in operation d) via which the mobile device indicates its intention, or requests permission, to use sensor-based timing synchronisation. The message of operation d) may, for instance, be sent to the base station following a determination in operation 5-1 of FIG. 5 that the mobile device should transition to the sensor-based timing synchronisation mode.

The capability report of operation a) and/or the message of operation d) may, for instance, indicate to the base station, a maximum duration for which the mobile device will/can use sensor-based timing synchronisation mode. This duration may for instance correspond with the interval/time threshold discussed with reference to operation 5-5 of FIG. 5. In addition or alternatively, the mobile device may indicate an expected accuracy of the sensor-based timing synchronisation (e.g. an expected propagation delay error expressed as a percentage or in units of time). The duration and/or the accuracy may be determined based on one or a combination of: known performance of the sensors, known performance of estimation algorithm, knowledge of the system, and/or, for instance, expected speeds/accelerations of the mobile device that may impact estimation accuracy. As mentioned above, the maximum duration for which the mobile device will/can use sensor-based timing synchronisation may correspond to a duration for which sensor-based estimation is expected to be sufficiently accurate (e.g., within a threshold accuracy).

Based on the information received from the mobile device, the base station may be configured to configure/adjust timing synchronisation parameters for use when the mobile device is operating in the sensor-based timing synchronisation mode. Such parameters may be communicated to the mobile device in operation b). Such timing synchronisation parameters may include parameters identifying discontinuous reception (DRX) cycles for determining when UE should monitor for downlink signals and/or intervals for transmission of reference time information. In some examples, the base station may also adjust transmission parameters such as reference signal formats, bandwidth, and number of consecutive transmissions, which may also be communicated to the mobile device.

In some examples, the timing synchronisation parameters may be for configuring a propagation delay estimation procedure with the mobile device. As mentioned above, these parameters may be determined based on the information received from the mobile device. Such parameters may indicate intervals that the base station has allocated for uplink transmission by the mobile device and/or intervals in which timing advance updates will be provided. In some implementations e.g. in which the timing advance is not (currently) being used, the parameters may instead indicate intervals in which the base station will transmit downlink reference signals and will monitor for uplink reference signal transmissions, thereby to enable RTT-based propagation delay estimation. In this way, the base station may reduce the number uplink/downlink exchanges that are performed, while still allowing the mobile device to perform uplink/downlink exchange-based propagation delay estimation, when it is expected to be necessary (e.g. based on the maximum interval and or accuracy information provided by the mobile device).

In some implementations, the mobile device may dynamically determine the accuracy and/or the interval in dependence on a current reliability of the sensors. The current accuracy and/or interval may, in some implementations, be communicated to the base station, e.g. in operation d), when the mobile device determines that it should transition into the sensor-based timing synchronisation mode.

The message of operation d) may request the base station to activate the sensor-based timing synchronisation mode. In some implementations, the request may indicate the duration for which the mobile device intends to use the sensor-based timing synchronisation mode. Alternatively, the message of operation d) may inform the base station that the mobile device is going to transition to the sensor-based timing synchronisation mode. It may additionally indicate when the transition will take place and/or a duration for which the mobile device intends to use the sensor-based timing synchronisation mode. The message of operation d) may for instance be conveyed via, e.g. a new, uplink control information message or via, e.g. a new, MAC information message. In some implementations, the mobile device may transmit the accuracy achievable with sensor-based estimation and/or the maximum interval via an assistance information (e.g. UEAssistanceInformation) message.

In operation e), the base station may respond to the message of operation d), for instance when it is a request, by instructing the mobile device to transition to the sensor-based timing synchronisation mode. In addition or alternatively, the instruction of operation e) may be sent by the base station in the absence of a request or indication from the mobile device of operation d). For instance, the instruction may be sent based on the knowledge (e.g. from operation a) that the mobile device is capable of operating in the sensor-based timing synchronisation mode.

The message of operation e) may, in some examples, define the time/interval threshold and/or the accuracy threshold. In other examples, these parameters may be indicated in the message of operation b).

The mobile device may be configured to respond to the message of operation e) by transitioning in the sensor-based timing synchronisation mode. As discussed previously, when operating in this mode (in operation g), the mobile device may not transmit uplink reference signals and/or may not receive timing advance information and/or reference signals for propagation delay determination from the base station. As illustrated in operation f) the base station may continue to periodically transmit SSB signals and reference time information. However, as shown in operation h), the base station may stop monitoring for uplink reference signals and/or transmitting downlink reference signals for use in propagation delay determination.

Although not shown in FIG. 7, the base station may also be configured to send an instruction for the mobile device to transition out of the sensor-based timing synchronisation mode (see e.g. operation 5-8 of FIG. 5).

Once it is determined (e.g. in operations 5-5 or 5-8 of FIG. 5) to transition out of the sensor-based timing synchronisation mode, the mobile device may transmit an uplink signal to the base station (in operation i). After this (for instance, in response), propagation delay determination that is based on the exchange of signals between the mobile device base station may be resumed (in operation j).

As discussed herein, use of sensor-based timing synchronisation may provide power savings for the mobile device, and in some implementations for the base station. FIG. 8 shows estimated mobile device/UE power saving gains which may be obtained by certain example implementations based on different assumptions of RTI periodicity and Rx-Tx periodicity. The estimations are based on UE power consumption model for FR1 [TR38.840] and it is assumed that UE can stay in the sensor-based timing synchronisation mode for 60 seconds without Rx-Tx signalling exchange, while just receiving DL SSB and RTI.

For two estimates (the two upper most line at the left hand side), it is assumed that, when not in the sensor-based timing synchronisation mode, Rx-Tx exchanges are performed as often as RTI transmissions, i.e. assuming the base station has no information about UE clock errors and PD variation. For the two other estimates (the bottom two lines on the left hand side), it is assumed that the periodicity of Rx-Tx exchanges is 960 ms, which assumes a moving UE with clock timing error of 1 ppm, i.e. for a 1 μs maximum error the UE needs a timing update at below is periodicity. In addition, two different UL TX power levels are assumed.

It can be seen that gain in terms of power saving ranges from 20% to 4× times better depending on UL power level and RTI periodicity. Such improvement can be translated also to reduction in unicast signalling overhead.

The examples of gains illustrated in FIG. 8 are based on one Rx-Tx signalling exchange per period. -Multiple Rx-Tx signalling exchanges may be used for reducing errors caused, e.g., by DL detection offsets due to multipath. As such, the power saving gains provided by use of the sensor-based timing synchronisation mode (in which Rx-Tx signalling exchange may be suspended) may actually be greater than illustrated in FIG. 8. In addition, as explained herein, various implementations of the disclosed technology may reduce air interface signalling and/or improve holdover capability for the mobile device to keep accurate timing with reduced UL/DL exchanges.

The estimations of FIG. 8 do not take into account the impact of power consumption of the sensors. This is based on the assumption that the sensors would already be used, e.g. for activity tracking on a smartwatch/smartphone device or motion control in a robot/drone. In addition, it is noted that sensors with low power consumption for IoT are available with current draining in the order of tens to hundreds of μA, and that sensors can be programmed to minimize power consumption impact by using wake up signals, e.g. sensors may be enabled if triggered by another low power sensor. It is therefore considered that the described mechanism may provide power savings even taking into account additional power used by the sensors (if any).

### Example Configurations of Apparatuses

FIG. 9 is a schematic illustration of an example configuration of a mobile device/UE 40 as described herein, which may be used for communicating with a base station 42 via a wireless interface. The eNB40 may be any device capable of at least sending or receiving radio signals to or from the base station and of performing operations as described above, in particular, but not exclusively, with reference to FIGS. 5 and 7.

The mobile device 40 (hereafter UE) may communicate via an appropriate radio interface arrangement 505 of the UE 40. The interface arrangement 505 may be provided for example by means of a radio part 505-2 (e.g. a transceiver) and an associated antenna arrangement 505-1. The antenna arrangement 505-1 may be arranged internally or externally to the UE 40.

The UE 40 comprises a controller/control (or processing) apparatus 50 which is operable to control the other components of the UE 40 in addition to performing any suitable combinations of the operations described in connection with UE 40 with reference to the preceding (where applicable). The control apparatus 50 may comprise processing apparatus 501 and memory 502. Computer-readable code 502-2A may be stored on the memory, which when executed by the processing apparatus 501, causes the control apparatus 50 to perform any of the operations described herein in relation to the UE 40. Also, the memory may include a transmission buffer 502-1B.

Example configurations of the memory 502 and processing apparatus 501 will be discussed in more detail below

The UE 40 may be, for example, a device that does not need human interaction, such as an entity that is involved in Machine Type Communications (MTC). Alternatively, the UE 40 may be a device designed for tasks involving human interaction such as making and receiving phone calls between users, and streaming multimedia or providing other digital content to a user. Non-limiting examples include a smart phone, and a laptop computer/notebook computer/tablet computer/e-reader device provided with a wireless interface facility.

Where the UE 40 is a device designed for human interaction, the user may control the operation of the UE 40 by means of a suitable user input interface UII 504 such as key pad, voice commands, touch sensitive screen or pad, combinations thereof or the like. A display 503, a speaker and a microphone may also be provided. Furthermore, the UE 40 may comprise appropriate connectors (either wired or wireless) to other devices and/or for connecting external accessories, for example hands-free equipment, thereto. The UE 40 is associated with (e.g. comprises or is in short range wired or wireless communication with) one or a plurality of motion sensors 504 for sensing motion of the mobile device. Examples of such sensors are described above.

FIG. 10 is a schematic illustration of an example configuration of a base station 42 as described herein, which may be used for communicating with the UEs 40 via a wireless interface. The base station 42 (e.g. gNB, eNodeB, or eNB), comprises a radio frequency antenna array 601 configured to receive and transmit radio frequency signals. Although the base station 42 in FIG. 10 is shown as having an array 601 of four antennas, this is illustrative only. The number of antennas may vary, for instance, from one to many hundreds.

The base station 42 further comprises radio frequency interface circuitry 603 configured to interface the radio frequency signals received and transmitted by the antenna 601 and the control apparatus 60. The radio frequency interface circuitry 603 may also be known as a transceiver. The apparatus 60 may also comprise an interface 609 via which, for example, it can communicate (e.g. via X2 messages) with other network elements such as the other base stations.

The base station control apparatus 60 may be configured to process signals from the radio frequency interface circuitry 603, control the radio frequency interface circuitry 603 to generate suitable RF signals to communicate information to the UEs 40 via the wireless communications link, and also to exchange information with other network elements via the interface 609.

The control apparatus 60 may comprise processing apparatus 602 and memory 604. Computer-readable code 604-2A may be stored on the memory 604, which when executed by the processing apparatus 602, causes the control apparatus 60 to perform any of the operations assigned to the base station 42 described above, in particular with reference to FIG. 7.

As should of course be appreciated, the apparatuses 40, 42 shown in each of FIGS. 9 and 10 described above may comprise further elements which are not directly involved with processes and operations in respect which this application is focussed.

Some further details of components and features of the above-described apparatus/entities/apparatuses 40, 42, 50, 60 and alternatives for them will now be described.

The control apparatuses 50, 60 may comprise processing apparatus 501, 602 communicatively coupled with memory 502, 604. The memory 502, 604 has computer readable instructions 502-2A, 604-2A stored thereon, which when executed by the processing apparatus 501, 602 causes the control apparatus 50, 60 to cause performance of various ones of the operations described herein. The control apparatus 50, 60 may in some instance be referred to, in general terms, as “apparatus”.

The processing apparatus 501, 602 may be of any suitable composition and may include one or more processors 50A, 602A of any suitable type or suitable combination of types. For example, the processing apparatus 501, 602 may be a programmable processor that interprets computer program instructions 502-2A, 604-2A and processes data. The processing apparatus 501, 602 may include plural programmable processors. Alternatively, the processing apparatus 501, 602 may be, for example, programmable hardware with embedded firmware. The processing apparatus 501, 602 may be termed processing means. The processing apparatus 501, 602 may alternatively or additionally include one or more Application Specific Integrated Circuits (ASICs). In some instances, processing apparatus 501, 602 may be referred to as computing apparatus.

The processing apparatus 501, 602 is coupled to the memory (which may be referred to as one or more storage devices) 502, 604 and is operable to read/write data to/from the memory 502, 604. The memory 502, 604 may comprise a single memory unit or a plurality of memory units, upon which the computer readable instructions (or code) 502-2A, 604-2A is stored. For example, the memory 502, 604 may comprise both volatile memory 502-1 and non-volatile memory 502-2. For example, the computer readable instructions/program code 502-2A, 604-2A may be stored in the non-volatile memory 502-2, 604-2 and may be executed by the processing apparatus 501, 602 using the volatile memory 502-1, 604-1 for temporary storage of data or data and instructions. In some examples, a transmission buffer 502-1B of the UE 40 may be constituted by volatile memory 502-1 of the UE control apparatus 50. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions/program code 502-2A, 604-2A may be pre-programmed into the control apparatus 20. Alternatively, the computer readable instructions 502-2A, 604-2A may arrive at the control apparatus 50, 60 via an electromagnetic carrier signal or may be copied from a physical entity 110 such as a computer program product, a memory device or a record medium such as a CD-ROM or DVD an example of which is illustrated in FIG. 11. The computer readable instructions 502-2A, 604-2A may provide the logic and routines that enables the entities devices/apparatuses 40, 42, 50, 60 to perform the functionality described above. The combination of computer-readable instructions stored on memory (of any of the types described above) may be referred to as a computer program product. Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing apparatus” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined. Similarly, it will also be appreciated that flow diagrams of FIGS. 5 and 7 are examples only and that various operations depicted therein may be omitted, reordered and or combined.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

It is to be understood that what is described above is what is presently considered the preferred embodiments. However, it should be noted that the description of the preferred embodiments is given by way of example only and that various modifications may be made without departing from the scope as defined by the appended claims.

1-21. (canceled)

22. An apparatus comprising:
at least one processor; and
at least one memory storing instructions that, when executed by the at least one processor, cause the apparatus at least to:
based on data from at least one motion sensor that is local to a mobile device, estimate a propagation delay of transmissions between a base station and the mobile device;
determine an updated timing information based on the estimated propagation delay; and
update an internal clock of the mobile device in accordance with the updated timing information.

23. The apparatus of claim 22, wherein the at least one memory stores instructions that, when executed by the at least one processor, cause the apparatus to:
determine whether the estimated propagation delay is at least one of:
valid, or
accurate;
in response to a determination that the estimated propagation delay is at least one of: valid, or accurate, update the internal clock of the mobile device in accordance with the updated timing information; and
in response to a determination that the estimated propagation delay is not at least one of: valid, or accurate, transition the mobile device out of a sensor-based timing synchronisation mode in which the propagation delay is estimated based on the data from the at least one motion sensor that is local to the mobile device.

24. The apparatus of claim 23, wherein the determining of whether the estimated propagation delay is at least one of valid, or accurate comprises:
determining whether a duration of time for which the mobile device has been in the sensor-based timing synchronisation mode exceeds a time threshold; and
in response to a determination that the duration of time for which the mobile device has been in the sensor-based timing synchronisation mode exceeds the time threshold, determining that the estimated propagation delay is not at least one of: valid, or accurate.

25. The apparatus of claim 23, wherein the determining of whether the estimated propagation delay is at least one of valid, or accurate comprises:
determining whether the estimated propagation delay is less accurate than a threshold accuracy; and
in response to a determination that the estimated propagation delay is less accurate than the threshold accuracy, determining that the estimated propagation delay is not at least one of: valid, or accurate.

26. The apparatus of claim 25, wherein the determining of whether the estimated propagation delay is less accurate than the threshold accuracy comprises:
comparing an expected time of arrival at the mobile device of a transmission from the base station with a measured time of arrival of the transmission, wherein the expected time of arrival comprises a time of arrival estimated based on the estimated propagation delay; and
in response to a difference between the measured time of arrival and the expected time of arrival is greater than a threshold difference, determining that the estimated propagation delay is less accurate than the threshold accuracy.

27. The apparatus of claim 22, wherein the mobile device is operating in a sensor-based timing synchronisation mode in which the propagation delay is estimated based on the data from the at least one motion sensor that is local to the mobile device, wherein the at least one memory stores instructions that, when executed by the at least one processor, cause the apparatus to at least one of:
monitor downlink transmissions from the base station less often than when the mobile device is not operating in the sensor-based timing synchronisation mode;
receive the downlink transmissions from the base station less often than when the mobile device is not operating in the sensor-based timing synchronisation mode;
cause suspension of uplink transmissions from the mobile device to the base station; or
cause transmission of fewer uplink transmissions from the mobile device to the base station than when the mobile device is not operating in the sensor-based timing synchronisation mode.

28. The apparatus of claim 22, wherein the at least one memory stores instructions that, when executed by the at least one processor, cause the apparatus to:
determine to transition the mobile device into a sensor-based timing synchronisation mode in which the propagation delay is estimated based on the data from the at least one motion sensor that is local to the mobile device based on at least one of:
a determination to reduce power usage of the mobile device,
a determination that an ability to exchange transmissions with the base station has become, or is expected to become, less reliable, or
a determination that the mobile device is, or will be, handed over from being served with the base station to being served with an at least partially different base station.

29. The apparatus of claim 22, wherein the at least one memory stores instructions that, when executed by the at least one processor, cause the apparatus to:
transmit, to the base station, a message indicative that the mobile device is capable of operating in a sensor-based timing synchronisation mode in which the propagation delay is estimated based on the data from the at least one motion sensor that is local to the mobile device.

30. The apparatus of claim 29, wherein the at least one memory stores instructions that, when executed by the at least one processor, cause the apparatus to, after transmission of the message, at least one of:
receive, from the base station, timing synchronisation parameters indicative of downlink signal timings for use in the sensor-based timing synchronisation mode; or
receive, from the base station, an instruction to operate in the sensor-based timing synchronisation mode.

31. The apparatus of claim 22, wherein the at least one memory stores instructions that, when executed by the at least one processor, cause the apparatus to:
transmit, to the base station, at least one of:
an indication of an intent to transition the mobile device into a sensor-based timing synchronisation mode in which the propagation delay is estimated based on the data from the at least one motion sensor that is local to the mobile device,
a request for permission to transition the mobile device into the sensor-based timing synchronisation mode,
information indicative of a maximum duration for which the mobile device will remain in the sensor-based timing synchronisation mode before transitioning out of the sensor-based timing synchronisation mode, or
information indicative of an estimated accuracy for the updated timing information when the mobile device is operating in the sensor-based timing synchronisation mode.

32. A method comprising:
based on data from at least one motion sensor that is local to a mobile device, estimating a propagation delay of transmissions between a base station and the mobile device;
determining an updated timing information based on the estimated propagation delay; and
updating an internal clock of the mobile device in accordance with the updated timing information.

33. The method of claim 32, further comprising:
determining whether the estimated propagation delay is at least one of:
valid, or
accurate;
in response to a determination that the estimated propagation delay is at least one of: valid, or accurate, updating the internal clock of the mobile device in accordance with the updated timing information; and
in response to a determination that the estimated propagation delay is not at least one of: valid, or accurate, transitioning the mobile device out of a sensor-based timing synchronisation mode in which the propagation delay is estimated based on the data from the at least one motion sensor that is local to the mobile device.

34. The method of claim 33, wherein the determining of whether the estimated propagation delay is at least one of valid, or accurate comprises:
determining whether a duration of time for which the mobile device has been in the sensor-based timing synchronisation mode exceeds a time threshold; and
in response to a determination that the duration of time for which the mobile device has been in the sensor-based timing synchronisation mode exceeds the time threshold, determining that the estimated propagation delay is not at least one of: valid, or accurate.

35. The method of claim 33, wherein the determining of whether the estimated propagation delay is at least one of valid, or accurate comprises:
determining whether the estimated propagation delay is less accurate than a threshold accuracy; and
in response to a determination that the estimated propagation delay is less accurate than the threshold accuracy, determining that the estimated propagation delay is not at least one of: valid, or accurate.

36. The method of claim 35, wherein the determining of whether the estimated propagation delay is less accurate than the threshold accuracy comprises:
comparing an expected time of arrival at the mobile device of a transmission from the base station with a measured time of arrival of the transmission, wherein the expected time of arrival comprises a time of arrival estimated based on the estimated propagation delay; and
in response to a difference between the measured time of arrival and the expected time of arrival is greater than a threshold difference, determining that the estimated propagation delay is less accurate than the threshold accuracy.

37. The method of claim 32, wherein the mobile device is operating in a sensor-based timing synchronisation mode in which the propagation delay is estimated based on the data from the at least one motion sensor that is local to the mobile device, wherein the method further comprises at least one of:
monitoring downlink transmissions from the base station less often than when the mobile device is not operating in the sensor-based timing synchronisation mode;
receiving the downlink transmissions from the base station less often than when the mobile device is not operating in the sensor-based timing synchronisation mode;
causing suspension of uplink transmissions from the mobile device to the base station; or
causing transmission of fewer uplink transmissions from the mobile device to the base station than when the mobile device is not operating in the sensor-based timing synchronisation mode.

38. The method of claim 32, further comprising:
determining to transition the mobile device into a sensor-based timing synchronisation mode in which the propagation delay is estimated based on the data from the at least one motion sensor that is local to the mobile device based on at least one of:
a determination to reduce power usage of the mobile device,
a determination that an ability to exchange transmissions with the base station has become, or is expected to become, less reliable, or
a determination that the mobile device is, or will be, handed over from being served with the base station to being served with an at least partially different base station.

39. The method of claim 32, further comprising:
transmitting, to the base station, a message indicative that the mobile device is capable of operating in a sensor-based timing synchronisation mode in which the propagation delay is estimated based on the data from the at least one motion sensor that is local to the mobile device.

40. The method of claim 32, further comprising:
transmitting, to the base station, at least one of:
an indication of an intent to transition the mobile device into a sensor-based timing synchronisation mode in which the propagation delay is estimated based on the data from the at least one motion sensor that is local to the mobile device,
a request for permission to transition the mobile device into the sensor-based timing synchronisation mode,
information indicative of a maximum duration for which the mobile device will remain in the sensor-based timing synchronisation mode before transitioning out of the sensor-based timing synchronisation mode, or
information indicative of an estimated accuracy for the updated timing information when the mobile device is operating in the sensor-based timing synchronisation mode.

41. A computer-readable medium comprising program instructions stored thereon for performing at least the following:
based on data from at least one motion sensor that is local to a mobile device, estimating a propagation delay of transmissions between a base station and the mobile device;
determining an updated timing information based on the estimated propagation delay; and
updating an internal clock of the mobile device in accordance with the updated timing information.
